(19) United States
(12) Patent Application Publication
(10) Pub. No.: US 2024/0231307 A9
(43) Pub. Date: Jul. 11, 2024

(54) Identifying Machine-Based Critical Zones

(71) Applicant: International Business Machines Corporation, Armonk, NY (US)

(72) Inventors: Shailendra Moyal, Pune (IN); Sarbajit K. Rakshit, Kolkata (IN); Partho Ghosh, Kolkata (IN)

(21) Appl. No.: 18/048,078

(22) Filed: Oct. 20, 2022

(51) Int. Cl. G05B 19/4061; G05B 19/418

(52) U.S. Cl. CPC G05B 19/4061; G05B 19/41885; G05B 2219/32014; G05B 2219/50193

(57) ABSTRACT

Identifying critical zones of machines is provided. A digital twin simulation of a machine is performed. An analysis of a set of historical incident records corresponding to the machine is performed to determine areas surrounding the machine that will be impacted by propagation of different types of incidents corresponding to the machine. A task performed by the machine, an operating context of the machine, an aggregate energy of the machine, and an area in the industrial machine environment affected by propagation of released energy from the machine are identified based on the digital twin simulation and the analysis of the set of historical incident records. A set of critical zones corresponding to the machine is identified based on the task performed by the machine, the operating context of the machine, the aggregate energy of the machine, and the area in the industrial machine environment affected by propagation of released energy.

### BACKGROUND

### 1. Field

The disclosure relates generally to industrial machine environments and more specifically to identifying critical zones of machines located in an industrial machine environment based on digital twin simulations of the machines to determine machine operating contexts and analysis of historical machine incident records to determine propagation of predicted incident impact across the industrial machine environment.

### 2. Description of the Related Art

Industrial machine environments are generally complex environments with a plurality of different industrial machines moving and performing a plurality of different tasks. In any industrial machine environment, attention needs to be paid to worker safety. For example, workers are exposed to extreme conditions in an industrial machine environment. As a result, workers in an industrial machine environment should follow safety precautions and use protective equipment, such as, for example, hardhats, safety glasses, hearing protectors, gloves, boots, and the like. Well-implemented safety precautions keep workers safe and also protect the industrial machines in the environment.

### SUMMARY

According to one illustrative embodiment, a computer-implemented method for identifying critical zones of machines is provided. A computer performs a digital twin simulation of a machine of a plurality of machines in an industrial machine environment using a digital twin computing system. The computer performs an analysis of a set of historical incident records corresponding to the machine while previously operating in the industrial machine environment to determine areas surrounding the machine in the industrial machine environment that will be impacted by propagation of different types of incidents corresponding to the machine. The computer identifies a task performed by the machine, an operating context of the machine, an aggregate energy of the machine, and an area in the industrial machine environment affected by propagation of released energy from the machine based on the digital twin simulation of the machine and the analysis of the set of historical incident records corresponding to the machine. The computer identifies a set of critical zones corresponding to the machine and an intensity level of each respective critical zone of the set of critical zones based on the task performed by the machine, the operating context of the machine, the aggregate energy of the machine, and the area in the industrial machine environment affected by propagation of released energy from the machine. According to other illustrative embodiments, a computer system and computer program product for identifying critical zones of machines are provided.

### BRIEF DESCRIPTION OF THE DRAWINGS

FIG. 1 is a pictorial representation of a computing environment in which illustrative embodiments may be implemented;

FIG. 2 is a diagram illustrating an example of a machine critical zone identification system in accordance with an illustrative embodiment;

FIGS. 3A-3B are a flowchart illustrating a process for identifying critical zones of machines in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc), or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

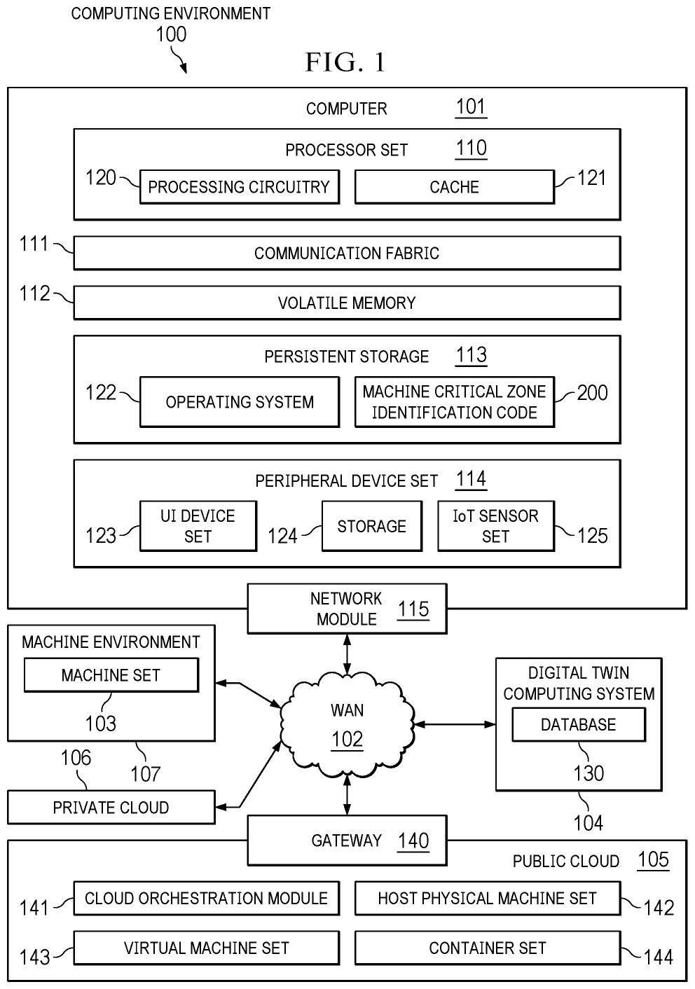

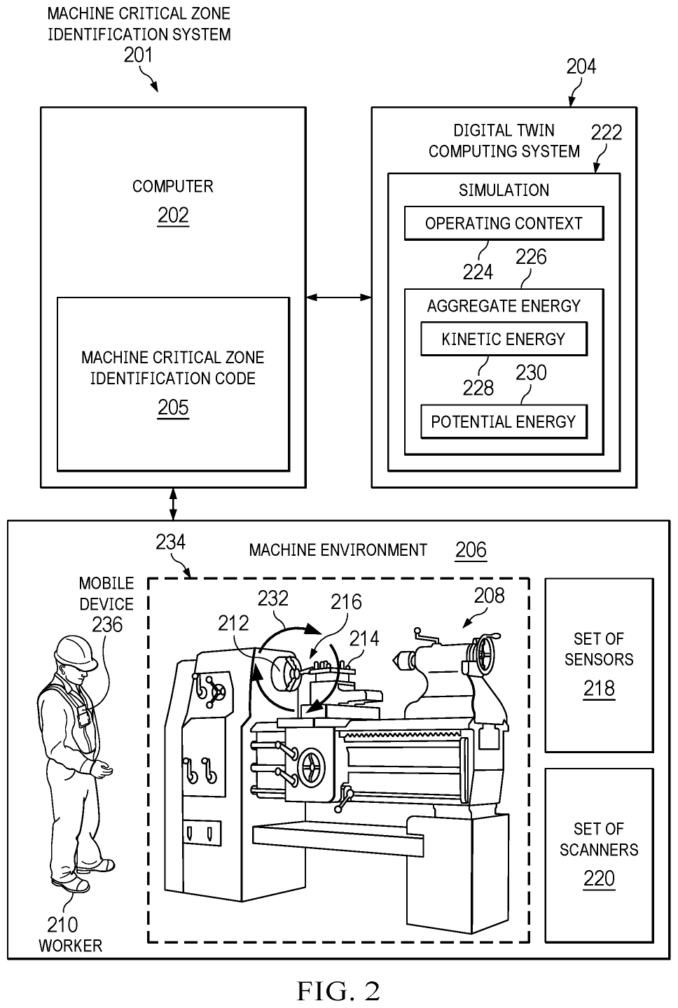

With reference now to the figures, and in particular, with reference to FIGS. 1-2, diagrams of data processing environments are provided in which illustrative embodiments may be implemented. It should be appreciated that FIGS. 1-2 are only meant as examples and are not intended to assert or imply any limitation with regard to the environments in which different embodiments may be implemented. Many modifications to the depicted environments may be made.

FIG. 1 shows a pictorial representation of a computing environment in which illustrative embodiments may be implemented. Computing environment 100 contains an example of an environment for the execution of at least some of the computer code involved in performing the inventive methods, such as machine critical zone identification code 200. Machine critical zone identification code 200 identifies critical zones of machines located in an industrial machine environment by performing digital twin simulations of the machines to identify operating contexts of the machines and by analyzing historical incident records of the machines to determine propagation of worker accident impact of predicted incidents (e.g., released energy) across the industrial machine environment.

A digital twin is a virtual model designed to accurately reflect a physical object (i.e., a physical industrial machine). The industrial machine that is being studied is typically outfitted with various sensors related to areas of machine functionality (e.g., moving component parts). These sensors generate data regarding different aspects of the physical machine's operating parameters and task performance, such as, for example, type of task performed, type and amount of energy output, temperature, environmental conditions, and the like. This generated data is then input into a digital twin computing system (e.g., digital twin computing system 104) and applied to the virtual model (i.e., the digital twin of the industrial machine). In response to receiving the generated data, the digital twin computing system runs different simulations on the digital twin of the industrial machine to determine, for example, machine operating context, machine performance under different conditions, potential incidents, incident propagation impact, and the like.

In addition to machine critical zone identification code block 200, computing environment 100 includes, for example, computer 101, wide area network (WAN) 102, machine set 103, digital twin computing system 104, public cloud 105, and private cloud 106. In this embodiment, computer 101 includes processor set 110 (including processing circuitry 120 and cache 121), communication fabric 111, volatile memory 112, persistent storage 113 (including operating system 122 and machine critical zone identification code 200, as identified above), peripheral device set 114 (including user interface (UI) device set 123, storage 124, and Internet of Things (IoT) sensor set 125), and network module 115. Digital twin computing system 104 includes database 130. Public cloud 105 includes gateway 140, cloud orchestration module 141, host physical machine set 142, virtual machine set 143, and container set 144.

Computer 101 may take the form of a desktop computer, laptop computer, tablet computer, mainframe computer, quantum computer, or any other form of computer or mobile device now known or to be developed in the future that is capable of running a program, accessing a network, or querying a database, such as database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in machine critical zone identification code block 200 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports, and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The machine critical zone identification code included in block 200 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks, and even connections made through wide area networks such as the Internet. In various embodiments, UI device set 123 may include components such as a display screen, speaker, microphone, wearable devices (such as smart glasses and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

Machine set 103 represents a set of industrial machines, such as, for example, lathes, grinders, drills, presses, and the like, located in machine environment 107. Machine set 103 can represent automated machines, manually operated machines, or a combination thereof. Machine environment 107 can represent any type of industrial machine environment or machine shop floor that is owned or managed by an entity, such as, for example, an enterprise, company, business, organization, institution, or the like.

Computer 101 receives relevant and useful data from the operations of machine set 103. For example, in a hypothetical case where computer 101 is designed to provide safety equipment recommendations and machine critical zone alerts to workers corresponding to machine set 103 in machine environment 107, these safety equipment recommendations and machine critical zone alerts would typically be communicated from network module 115 of computer 101 through WAN 102 to the workers via, for example, augmented reality devices worn by the workers. In this way, the augmented reality devices can display, or otherwise present, the safety equipment recommendations and machine critical zones to the workers. In some embodiments, the augmented reality devices may be client devices of computer 101.

Digital twin computing system 104 is any computer system that serves at least some data and/or functionality to computer 101. Digital twin computing system 104 may be controlled and used by the same entity that operates computer 101. Digital twin computing system 104 represents the data processing system(s) that generates and store helpful and useful data for use by other computers, such as computer 101. For example, in a hypothetical case where computer 101 is designed and programmed to provide safety equipment recommendations and machine critical zone alerts based on historical data, then this historical data may be provided to computer 101 from database 130 of digital twin computing system 104. However, in an alternative illustrative embodiment, digital twin computing system 104 is a component of computer 101.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

As used herein, when used with reference to items, “a set of” means one or more of the items. For example, a set of clouds is one or more different types of cloud environments. Similarly, “a number of,” when used with reference to items, means one or more of the items.

Further, the term “at least one of,” when used with a list of items, means different combinations of one or more of the listed items may be used, and only one of each item in the list may be needed. In other words, “at least one of” means any combination of items and number of items may be used from the list, but not all of the items in the list are required. The item may be a particular object, a thing, or a category.

For example, without limitation, “at least one of item A, item B, or item C” may include item A, item A and item B, or item B. This example may also include item A, item B, and item C or item B and item C. Of course, any combinations of these items may be present. In some illustrative examples, “at least one of” may be, for example, without limitation, two of item A; one of item B; and ten of item C; four of item B and seven of item C; or other suitable combinations.

In any industrial machine or machine shop environment, a plurality of different types of machines exists that perform a plurality of different types of tasks or activities. Some of these machines operate automatically, while other machines are manually operated. These machines perform their corresponding tasks or activities with various operational parameters, such as, for example, speed of moving parts, amount of heat generated, amount and type of lubricant and coolant needed, amount of debris or fragments generated, debris velocity, amount of exhaust, exhaust toxicity, chemicals used, and the like. The different operational parameters of the different types of machines are important to know for worker safety reasons. For example, when the rotational speed of a machine part is approaching a defined maximum speed threshold level, then the likelihood of an incident occurring goes up as compared to when that machine part is operating at a lower rotational speed. For example, the rotating machine part may fail and break into multiple pieces, sending these pieces flying into the surrounding area potentially causing injury to workers when the defined maximum speed threshold level is exceeded. Also, the likelihood of an incident occurring can depend on other factors, such as, for example, type of material being processed or manipulated by that particular machine, gripping force applied to the material being processed, apparatus provided by that particular machine to protect workers, and the like.

Worker safety is a high priority in these industrial machine environments because workers being unaware of machine operational parameters and movements can result in serious worker injury. For example, a mobile machine, such as an overhead crane, can be operating in an area where a worker is also present performing assigned job duties. In addition, while performing assigned job duties in that area, the worker may look at a mobile device or wearable device (e.g., mobile phone, smart watch, or the like) for more than a threshold time limit. This distraction of the worker looking at a mobile or wearable device may result in that worker being involved in an accident with the mobile machine. As a result, an intelligent solution is needed to alert workers of machine operating parameters and movements so that accidents can be avoided.

Illustrative embodiments utilize a digital twin computing system to simulate any machine in any industrial machine environment to identify, for example, any potential and kinetic energy of that particular machine that can cause an incident, safe boundary or distance from that particular machine on all sides, and the like, based on an identified operating context of that particular machine. Illustrative embodiments define a critical zone for that particular machine when that particular machine is operating according to its identified operating context. Illustrative embodiments identify a particular machine's operating context based on, for example, task or activity being performed by that particular machine (e.g., cutting metal pieces), specified operational parameters (e.g., type of metal being cut, rotational speed of the machine's metal cutting tool, type and amount of coolant used for that particular machine, amount of metal shavings being produced, and the like), level of worker protection provided by that particular machine (e.g., protective cover over the metal cutting tool, no protective cover for the metal cutting tool, or the like), level of protection needed by workers working with or near that particular machine (e.g., hard hat, safety glasses, ear plugs, gloves, boots, and other protective equipment), and the like.

Further, illustrative embodiments identify mobility of machines in the industrial machine environment and the navigation paths corresponding to those mobile machines. Based on the navigation path of a particular mobile machine and type of tasks or activities being performed by that particular mobile machine along its navigation path, illustrative embodiments utilize the digital twin computing system to perform a digital twin simulation of that particular mobile machine to identify a critical zone around that particular mobile machine. The critical zone is a defined area or space surrounding a component part of that particular machine within which an incident (e.g., release of energy, release of fragments, released of hot fluid, accident, worker injury, or the like) potentially causing worker injury can occur when that particular machine is performing its task or activity.

Based on the result of the digital twin simulation of that particular machine, illustrative embodiments identify a set of critical zones corresponding to that particular machine and an intensity level (e.g., high, medium, low) of each respective critical zone of the set of critical zones. For example, a high intensity level of a critical zone surrounding a particular component part of that particular machine may be where a worker is manually feeding metal sheets into a high-speed punch press of that particular machine and the likelihood of series worker injury is high if a predicted incident occurs. For each and every critical zone and its corresponding intensity level, illustrative embodiments restrict different types of worker activities (e.g., looking at mobile or wearable devices) and alert workers as to the level of attention needed by workers to perform their job duties in a particular critical zone corresponding to that particular machine. Also based on the result of the digital twin simulation of that particular machine, illustrative embodiments alert workers as to the type and amount of protection workers need to wear to perform their job duties within a particular critical zone of that particular machine (e.g., wear polarized protective goggles, flame resistant gloves, steel-toed boots, full body protective suit, and the like) via, for example, an augmented reality device.

In addition, illustrative embodiments analyze maintenance records corresponding to that particular machine to identify the age and health of that particular machine and its component parts. Furthermore, illustrative embodiments also analyze any historical incident records corresponding to that particular machine while previously operating in its physical environment (i.e., industrial machine environment) to determine areas surrounding that particular machine that can be impacted by propagation of different types of incidents (e.g., release of kinetic or potential energy from that particular machine) across the industrial machine environment. As an illustrative scenario, a previous incident involved a plastic protective cover shattering on that particular machine causing shards of the shattered plastic protective cover to fly in several different directions several feet from that particular machine. As a result, illustrative embodiments can identify the areas of the industrial machine environment that will be impacted by any simulated incident scenario corresponding to that particular machine. In other words, illustrative embodiments are capable of determining how a predicted incident can be propagated or spread across the industrial machine environment.

Further, illustrative embodiments identify any mobile or wearable device that is present on a worker within an identified critical zone of that particular machine. In response to identifying that a worker has a mobile device or wearable device in the identified critical zone, illustrative embodiments automatically deactivate or limit a specified set of functionalities of the mobile device or wearable device while the worker is in the identified critical zone so that distractions, which can lead to worker injury, can be avoided.

Furthermore, based on the task or activity being performed on that particular machine, illustrative embodiments will display on the augmented reality device, such as, for example, a head-mounted augmented reality display, an alert and safe boundary or path for workers present and moving around that particular device. For example, illustrative embodiments will display the alert and safe boundary for a particular worker around that particular machine based on the type and level of safety equipment protection worn by that particular worker.

Illustrative embodiments utilize the digital twin simulation of that particular machine to identify in advance the critical zone based on the task or activity to be performed by that particular machine. By identifying the critical zone in advance, illustrative embodiments are capable of taking proactive precautionary measures to protect workers around that particular machine when an incident is predicted to occur at a particular time.

Illustrative embodiments are also capable of monitoring and taking into account other influential factors, such as, for example, temperature variation, air flow direction, and the like, within the industrial machine environment to adjust or modify in real time at least one of the size or the shape of a particular critical zone of that particular machine based on the type of predicted incident that can occur and whether an impact of the predicted incident can be affected by any of the monitored influential factors. For example, illustrative embodiments can determine whether a predicted increase of high temperatures around a particular machine can be affected by air flow direction in the industrial machine environment and, therefore, automatically change the size and shape of the critical zone around that particular machine in the direction of the current air flow.

Moreover, illustrative embodiments enable security and safety systems in the industrial machine environment to be pro-active in advance when a predicted incident actually occurs using data received from illustrative embodiments regarding machine critical zone information and the impact an incident can have on workers in the industrial machine environment.

Illustrative embodiments utilize the digital twin computing system to identify each component part that is moving (e.g., rotating, conveying, stamping, cutting, grinding, shaving, shaping, pouring, spraying, or the like) on a particular machine. Illustrative embodiments also utilize the digital twin computing system to identify the operating context (e.g., physical parameters) of component parts of that particular machine, such as, for example, rotational speed of a particular component part of that particular machine.

Further, illustrative embodiments utilize the digital twin computing system to simulate the entire workflow of that particular machine to calculate the aggregate energy of that particular machine. Illustrative embodiments calculate the aggregate energy of that particular machine based on the amount of determined kinetic energy and potential energy of that particular machine. Illustrative embodiments determine the kinetic energy of that particular machine based on which component parts and/or raw materials (e.g., work product) are moving on that particular machine, the speed at which these component parts and/or raw materials are moving, the mass of these moving component parts and/or raw materials, and the like. Illustrative embodiments determine the potential energy of that particular machine based on identifying any component part that has an ability to release energy, such as, for example, a compressed spring has the ability to release mechanical energy, a steam chamber has an ability to release thermal energy, and the like.

Thus, by utilizing the digital twin computing system to generate a digital twin simulation of all machines in the entire industrial machine environment, illustrative embodiments can predict which particular machine and which particular part of that particular machine has a high probability of releasing energy. If the energy is released from that particular machine, then the energy can potentially cause an incident (e.g., worker injury) in the surrounding area.

Based on the identified shape, dimensions, and structure of that particular machine, illustrative embodiments determine whether that particular machine can protect workers from the released energy and whether that protection is integral to the design of that particular machine. If the digital twin simulation shows that that particular machine cannot protect workers from the released energy, then illustrative embodiments determine the magnitude of the released energy from that particular machine based on the digital twin simulation. Based on the simulation of the magnitude of the released energy, illustrative embodiments identify how far the magnitude of the released energy will spread across the industrial machine environment. Based on the area where the released energy will spread across the industrial machine environment, illustrative embodiments classify that area of the released energy spread as an unsafe area (i.e., within a critical zone) corresponding to that particular machine within the industrial machine environment.

Illustrative embodiments also analyze data obtained from sensor feeds and scanner feeds corresponding to the different machines in the industrial machine environment to identify the health of the machines as to whether any component part of a particular machine is defective or is having a problem performing the assigned task or activity. Illustrative embodiments also identify the raw material used by that particular machine to perform its task or activity. In addition, illustrative embodiments utilize the sensor feeds and scanner feeds to detect workers and their locations within the industrial machine environment, detect whether any workers have mobile or wearable devices while in the industrial machine environment, detect type of protective equipment worn by each respective worker, and the like.

Furthermore, illustrative embodiments identify the relative positions of the different machines on the industrial machine environment and also identify which particular machines are mobile machines having a navigation path through the industrial machine environment. For example, illustrative embodiments identify which machines are moving from one place to another place along their navigation path within the industrial machine environment and the direction of their movement. Moreover, illustrative embodiments identify the positions of workers within the industrial machine environment. In addition, illustrative embodiments identify whether a particular worker is carrying a mobile or wearable device within a critical zone of a particular machine and will notify that particular worker regarding that device. Further, illustrative embodiments will disable or restrict specific functionality (e.g., receiving and sending text messages and calls) of the mobile device present within the critical zone and surrounding area that can potentially be impacted within the safe boundary. Illustrative embodiments can show the safe boundary corresponding to that particular machine to workers via an augmented reality headset worn by the workers while working in the industrial machine environment.

Thus, illustrative embodiments provide one or more technical solutions that overcome a technical problem with automatically identifying critical zones of machines in an industrial machine environment. As a result, these one or more technical solutions provide a technical effect and practical application in the field of machine critical zone identification for worker safety.

With reference now to FIG. 2, a diagram illustrating an example of a machine critical zone identification system is depicted in accordance with an illustrative embodiment. Machine critical zone identification system 201 may be implemented in a computing environment, such as computing environment 100 in FIG. 1. Machine critical zone identification system 201 is a system of hardware and software components for identifying critical zones of machines located in an industrial machine environment using digital twin simulations of the machines to identify machine operating contexts and performing historical machine incident record analysis to determine propagation of the impact of predicted incidents (e.g., released energy) across the industrial machine environment.

In this example, machine critical zone identification system 201 includes computer 202, digital twin computing system 204, and machine environment 206. Computer 202, digital twin computing system 204, and machine environment 206 may be, for example, computer 101, digital twin computing system 104, and machine environment 107 in FIG. 1. Further, in an alternative illustrative embodiment, computer 202 includes digital twin computing system 204. Also, it should be noted that machine critical zone identification system 201 is intended as an example only and not as a limitation on illustrative embodiments. For example, machine critical zone identification system 201 may include any number of computers, digital twin computing systems, machine environments, and other devices and components not shown.

Computer 202 includes machine critical zone identification code 205, such as, for example, machine critical zone identification code 200 in FIG. 1. Machine environment 206 includes machine 208 and worker 210. Machine 208 represents a physical machine. In this example, machine 208 is a lathe machine that shapes metal. For example, machine 208 includes revolving jaws 212 and metal cutting tool 214 for shaping raw metal material 216. However, it should be noted that machine 208 can represent any type of industrial machine and can represent a plurality of different types of machines located within machine environment 206.

In this example, worker 210 is an operator of machine 208. Worker 210 is wearing protective equipment, such as hardhat, safety glasses, and boots. Also, it should be noted that worker 210 can represent a plurality of workers present in machine environment 206.

Computer 202 utilizes at least one of set of sensors 218 or set of scanners 220 to detect the presence and location of worker 210 within machine environment 206. Computer 202 also utilizes set of sensors 218 and set of scanners 220 to generate data regarding the operation, performance, and health of machine 208 and each of its moving component parts (e.g., revolving jaws 212 and metal cutting tool 214). Further, it should be noted that a subset of set of sensors 218 and set of scanners 220 can be located on machine 208.

Computer 202 receives the data generated by set of sensors 218 and set of scanners 220 regarding the location of worker 210 in relation to machine 208 and the operation, performance, and health of machine 208 and each of its moving component parts and then sends that data to digital twin computing system 204. Digital twin computing system 204 utilizes the data to generate simulation 222. Simulation 222 is a digital twin simulation of machine 208 and can represent a plurality of digital twin simulations corresponding to machine 208.

Simulation 222 provides operating context 224 and aggregate energy 226 corresponding to machine 208. Operating context 224 includes task performed by machine 208 (e.g., cutting metal pieces), specified operational parameters (e.g., type of raw metal material 216 being cut, rotational speed of revolving jaws 212, speed of metal cutting tool 214, type and amount of coolant used for machine 208, amount of metal shavings produced, and the like), level of worker protection provided by machine 208 (e.g., protective cover over metal cutting tool 214 or no protective cover), type of safety equipment needed by worker 210 while working with machine 208 (e.g., hardhat, safety glasses, hearing protector, gloves, boots, and protective jumpsuit), and the like.

Aggregate energy 226 represents a total amount of energy that can be released from machine 208. In this example, aggregate energy 226 includes kinetic energy 228 and potential energy 230. However, it should be noted that aggregate energy 226 may include only kinetic energy 228 or may include only potential energy 230.

Simulation 222 determines amount of kinetic energy 228 of machine 208 based on which component parts and raw materials are moving on machine 208 (e.g., revolving jaws 212, metal cutting tool 214, and raw metal material 216), the speed at which these component parts and raw materials are moving on machine 208, the mass of these component parts and raw materials moving on machine 208, and the like. Simulation 222 determines the amount of potential energy 230 of machine 208 based on identifying any component part that has an ability to release energy, such as, for example, a pressurized coolant chamber has an ability to release liquid energy or the like.

Digital twin computing system 204 sends operating context 224 and aggregate energy 226 corresponding to machine 208 to computer 202. Computer 202 inputs operating context 224 and aggregate energy 226 corresponding to machine 208 into machine critical zone identification code 205. Machine critical zone identification code 205 identifies critical zone 232 of machine 208 based on operating context 224, aggregate energy 226, and type of safety equipment worn by worker 210. In addition, machine critical zone identification code 205 identifies safe boundary 234 for other workers moving in machine environment 206 based on propagation of the impact of aggregate energy 226 being released from machine 208 across machine environment 206.

Moreover, computer 202 utilizes at least one of set of sensors 218 or set of scanners 220 to detect that worker 210 has mobile device 236 while working in critical zone 232 of machine 208. Mobile device 236 can represent, for example, a mobile phone, a smart watch, or any other type of mobile device that can distract worker 210. In response to detecting that mobile device 236 is present while worker 210 is working in critical zone 232, computer 202 deactivates or restricts certain functionalities of mobile device 236 until worker 210 moves away from machine 208.

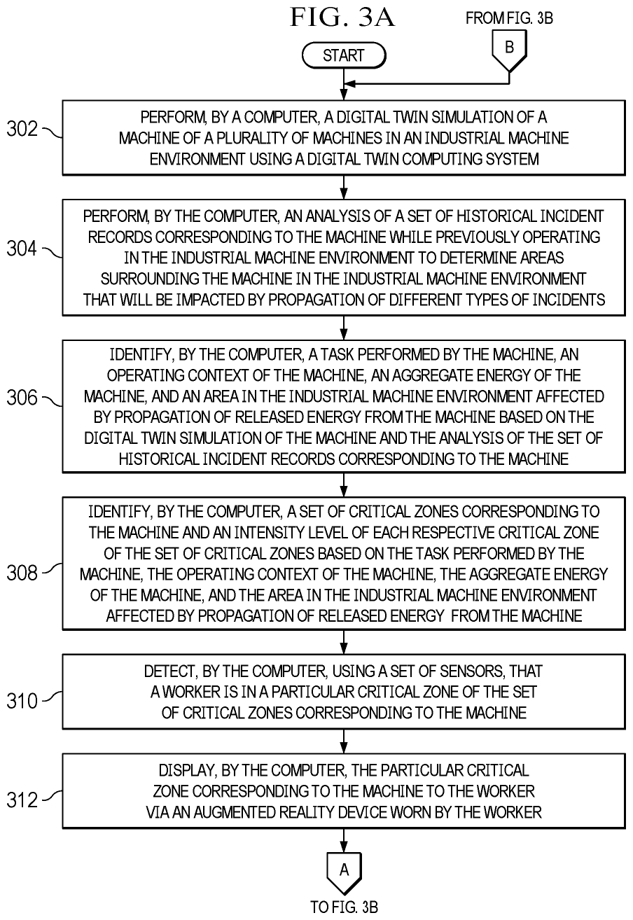

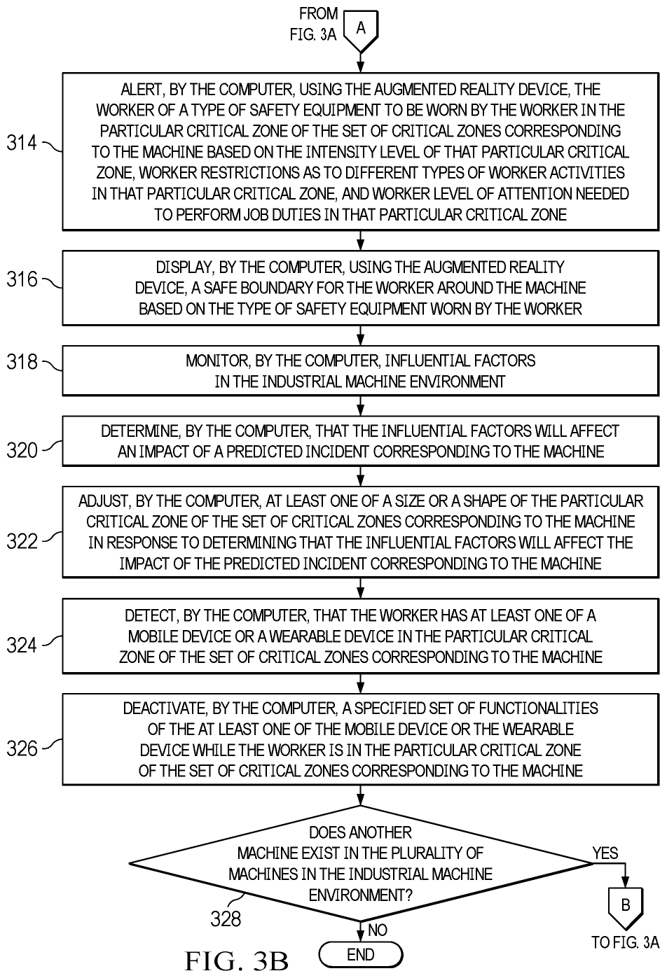

With reference now to FIGS. 3A-3B, a flowchart illustrating a process for identifying critical zones of machines is shown in accordance with an illustrative embodiment. The process shown in FIGS. 3A-3B may be implemented in a computer, such as, for example, computer 101 in FIG. 1 or computer 202 in FIG. 2. For example, the process shown in FIGS. 3A-3B may be implemented in machine critical zone identification code 200 in FIG. 1 or machine critical zone identification code 205 in FIG. 2.

The process begins when the computer performs a digital twin simulation of a machine of a plurality of machines in an industrial machine environment using a digital twin computing system (step 302). The digital twin simulation may be, for example, simulation 222 of FIG. 2. The machine may be, for example, a machine in machine set 103 in FIG. 1 or machine 208 in FIG. 2. The industrial machine environment may be, for example, machine environment 107 in FIG. 1 or machine environment 206 in FIG. 2. The digital twin system may be, for example, digital twin computing system 104 in FIG. 1 or digital twin computing system 204 in FIG. 2.

In addition, the computer performs an analysis of a set of historical incident records corresponding to the machine while previously operating in the industrial machine environment to determine areas surrounding the machine in the industrial machine environment that will be impacted by propagation of different types of incidents corresponding to the machine (step 304). The computer identifies a task performed by the machine, an operating context of the machine, an aggregate energy of the machine, and an area in the industrial machine environment affected by propagation of released energy from the machine based on the digital twin simulation of the machine and the analysis of the set of historical incident records corresponding to the machine (step 306).

Further, the computer identifies a set of critical zones corresponding to the machine and an intensity level of each respective critical zone of the set of critical zones based on the task performed by the machine, the operating context of the machine, the aggregate energy of the machine, and the area in the industrial machine environment affected by propagation of released energy from the machine (step 308). Furthermore, the computer, using a set of sensors, detects that a worker is in a particular critical zone of the set of critical zones corresponding to the machine (step 310). The set of sensors may be, for example, set of sensors 218 in FIG. 2. The computer displays the particular critical zone corresponding to the machine to the worker via an augmented reality device worn by the worker (step 312).

The computer, using the augmented reality device, alerts the worker of a type of safety equipment to be worn by the worker in the particular critical zone of the set of critical zones corresponding to the machine based on the intensity level of that particular critical zone, worker restrictions as to different types of worker activities in that particular critical zone, and worker level of attention needed to perform job duties in that particular critical zone (step 314). Moreover, the computer, using the augmented reality device, displays a safe boundary around the machine for the worker based on the type of safety equipment worn by the worker (step 316).

The computer also monitors influential factors in the industrial machine environment (step 318). The computer determines that the influential factors will affect an impact of a predicted incident corresponding to the machine (step 320). The computer adjusts at least one of a size or a shape of the particular critical zone of the set of critical zones corresponding to the machine in response to determining that the influential factors will affect the impact of the predicted incident corresponding to the machine (step 322).

In addition, the computer detects that the worker has at least one of a mobile device or a wearable device in the particular critical zone of the set of critical zones corresponding to the machine (step 324). The computer deactivates a specified set of functionalities of the at least one of the mobile device or the wearable device while the worker is in the particular critical zone of the set of critical zones corresponding to the machine (step 326).

Afterward, the computer makes a determination as to whether another machine exists in the plurality of machines in the industrial machine environment (step 328). If the computer determines that another machine does exist in the plurality of machines in the industrial machine environment, yes output of step 328, then the process returns to step 302 where the computer performs a digital twin simulation of another machine in the plurality of machines in the industrial machine environment. If the computer determines that another machine does not exist in the plurality of machines in the industrial machine environment, no output of step 328, then the process terminates thereafter.

Thus, illustrative embodiments of the present invention provide a computer-implemented method, computer system, and computer program product for identifying critical zones of machines located in an industrial machine environment based on digital twin simulations of the machines to determine machine operating contexts and analysis of historical machine incident records to determine propagation of predicted incident impact across the industrial machine environment. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for identifying critical zones of machines, the computer-implemented method comprising:
performing, by a computer, a digital twin simulation of a machine of a plurality of machines in an industrial machine environment using a digital twin computing system;
performing, by the computer, an analysis of a set of historical incident records corresponding to the machine while previously operating in the industrial machine environment to determine areas surrounding the machine in the industrial machine environment that will be impacted by propagation of different types of incidents corresponding to the machine;
identifying, by the computer, a task performed by the machine, an operating context of the machine, an aggregate energy of the machine, and an area in the industrial machine environment affected by propagation of released energy from the machine based on the digital twin simulation of the machine and the analysis of the set of historical incident records corresponding to the machine; and
identifying, by the computer, a set of critical zones corresponding to the machine and an intensity level of each respective critical zone of the set of critical zones based on the task performed by the machine, the operating context of the machine, the aggregate energy of the machine, and the area in the industrial machine environment affected by propagation of released energy from the machine.

2. The computer-implemented method of claim 1 further comprising:
detecting, by the computer, using a set of sensors, that a worker is in a particular critical zone of the set of critical zones corresponding to the machine;
displaying, by the computer, the particular critical zone corresponding to the machine to the worker via an augmented reality device worn by the worker; and
alerting, by the computer, using the augmented reality device, the worker of a type of safety equipment to be worn by the worker in the particular critical zone of the set of critical zones corresponding to the machine based on the intensity level of that particular critical zone, worker restrictions as to different types of worker activities in that particular critical zone, and worker level of attention needed to perform job duties in that particular critical zone.

3. The computer-implemented method of claim 2 further comprising:
displaying, by the computer, using the augmented reality device, a safe boundary around the machine for the worker based on the type of safety equipment worn by the worker.

4. The computer-implemented method of claim 2 further comprising:
monitoring, by the computer, influential factors in the industrial machine environment;
determining, by the computer, that the influential factors will affect an impact of a predicted incident corresponding to the machine; and
adjusting, by the computer, at least one of a size or a shape of the particular critical zone of the set of critical zones corresponding to the machine in response to determining that the influential factors will affect the impact of the predicted incident corresponding to the machine.

5. The computer-implemented method of claim 1 further comprising:
detecting, by the computer, that a worker has at least one of a mobile device or a wearable device in a critical zone of the set of critical zones corresponding to the machine; and
deactivating, by the computer, a specified set of functionalities of the at least one of the mobile device or the wearable device while the worker is in the critical zone of the set of critical zones corresponding to the machine.

6. The computer-implemented method of claim 1, wherein the aggregate energy includes at least one of potential energy or kinetic energy corresponding to the machine that can cause an incident.

7. The computer-implemented method of claim 6, wherein the kinetic energy of the machine is determined based on which component parts are moving on the machine, speed at which the component parts are moving, and mass of the component parts that are moving.

8. The computer-implemented method of claim 6, wherein the potential energy of the machine is determined based on identifying any component part of the machine that has an ability to release energy.

9. The computer-implemented method of claim 1, wherein a critical zone is a defined area surrounding a component part of the machine within which an incident can occur potentially causing worker injury when the machine is performing its task.

10. A computer system for identifying critical zones of machines, the computer system comprising:
a communication fabric;
a storage device connected to the communication fabric, wherein the storage device stores program instructions; and
a processor connected to the communication fabric, wherein the processor executes the program instructions to:
perform a digital twin simulation of a machine of a plurality of machines in an industrial machine environment using a digital twin computing system;
perform an analysis of a set of historical incident records corresponding to the machine while previously operating in the industrial machine environment to determine areas surrounding the machine in the industrial machine environment that will be impacted by propagation of different types of incidents corresponding to the machine;
identify a task performed by the machine, an operating context of the machine, an aggregate energy of the machine, and an area in the industrial machine environment affected by propagation of released energy from the machine based on the digital twin simulation of the machine and the analysis of the set of historical incident records corresponding to the machine; and
identify a set of critical zones corresponding to the machine and an intensity level of each respective critical zone of the set of critical zones based on the task performed by the machine, the operating context of the machine, the aggregate energy of the machine, and the area in the industrial machine environment affected by propagation of released energy from the machine.

11. The computer system of claim 10, wherein the processor further executes the program instructions to:
detect, using a set of sensors, that a worker is in a particular critical zone of the set of critical zones corresponding to the machine;
display the particular critical zone corresponding to the machine to the worker via an augmented reality device worn by the worker; and
alert, using the augmented reality device, the worker of a type of safety equipment to be worn by the worker in the particular critical zone of the set of critical zones corresponding to the machine based on the intensity level of that particular critical zone, worker restrictions as to different types of worker activities in that particular critical zone, and worker level of attention needed to perform job duties in that particular critical zone.

12. The computer system of claim 11, wherein the processor further executes the program instructions to:
display, using the augmented reality device, a safe boundary around the machine for the worker based on the type of safety equipment worn by the worker.

13. The computer system of claim 11, wherein the processor further executes the program instructions to:
monitor influential factors in the industrial machine environment;
determine that the influential factors will affect an impact of a predicted incident corresponding to the machine; and
adjust at least one of a size or a shape of the particular critical zone of the set of critical zones corresponding to the machine in response to determining that the influential factors will affect the impact of the predicted incident corresponding to the machine.

14. The computer system of claim 10, wherein the processor further executes the program instructions to:
detect that a worker has at least one of a mobile device or a wearable device in a critical zone of the set of critical zones corresponding to the machine; and
deactivate a specified set of functionalities of the at least one of the mobile device or the wearable device while the worker is in the critical zone of the set of critical zones corresponding to the machine.

15. A computer program product for identifying critical zones of machines, the computer program product comprising a computer-readable storage medium having program instructions embodied therewith, the program instructions executable by a computer to cause the computer to perform a method of:
performing, by the computer, a digital twin simulation of a machine of a plurality of machines in an industrial machine environment using a digital twin computing system;
performing, by the computer, an analysis of a set of historical incident records corresponding to the machine while previously operating in the industrial machine environment to determine areas surrounding the machine in the industrial machine environment that will be impacted by propagation of different types of incidents corresponding to the machine;
identifying, by the computer, a task performed by the machine, an operating context of the machine, an aggregate energy of the machine, and an area in the industrial machine environment affected by propagation of released energy from the machine based on the digital twin simulation of the machine and the analysis of the set of historical incident records corresponding to the machine; and
identifying, by the computer, a set of critical zones corresponding to the machine and an intensity level of each respective critical zone of the set of critical zones based on the task performed by the machine, the operating context of the machine, the aggregate energy of the machine, and the area in the industrial machine environment affected by propagation of released energy from the machine.

16. The computer program product of claim 15 further comprising:
detecting, by the computer, using a set of sensors, that a worker is in a particular critical zone of the set of critical zones corresponding to the machine;
displaying, by the computer, the particular critical zone corresponding to the machine to the worker via an augmented reality device worn by the worker; and
alerting, by the computer, using the augmented reality device, the worker of a type of safety equipment to be worn by the worker in the particular critical zone of the set of critical zones corresponding to the machine based on the intensity level of that particular critical zone, worker restrictions as to different types of worker activities in that particular critical zone, and worker level of attention needed to perform job duties in that particular critical zone.

17. The computer program product of claim 16 further comprising:
displaying, by the computer, using the augmented reality device, a safe boundary around the machine for the worker based on the type of safety equipment worn by the worker.

18. The computer program product of claim 16 further comprising:
monitoring, by the computer, influential factors in the industrial machine environment;
determining, by the computer, that the influential factors will affect an impact of a predicted incident corresponding to the machine; and
adjusting, by the computer, at least one of a size or a shape of the particular critical zone of the set of critical zones corresponding to the machine in response to determining that the influential factors will affect the impact of the predicted incident corresponding to the machine.

19. The computer program product of claim 15 further comprising:
detecting, by the computer, that a worker has at least one of a mobile device or a wearable device in a critical zone of the set of critical zones corresponding to the machine; and
deactivating, by the computer, a specified set of functionalities of the at least one of the mobile device or the wearable device while the worker is in the critical zone of the set of critical zones corresponding to the machine.

20. The computer program product of claim 15, wherein the aggregate energy includes at least one of potential energy or kinetic energy corresponding to the machine that can cause an incident.
